(19) United States
(12) Patent Application Publication
(10) Pub. No.: US 2006/0283299 A1
(43) Pub. Date: Dec. 21, 2006

(54) Food slicer with suction device and adjustable cutting surface

(75) Inventors: Christopher M. Mellen, New York, NY (US); Louis F. Henry, Scarsdale, NY (US)

Correspondence Address: LATHROP & GAGE LC, 2345 GRAND AVENUE, SUITE 2800, KANSAS CITY, MO, 64108, US

(73) Assignee: Design For Living, L.L.C.

(21) Appl. No.: 11/337,021

(22) Filed: Jan. 20, 2006

Related U.S. Application Data
(63) Continuation-in-part of application No. 29/232,222, filed on Jun. 16, 2005.
(63) Continuation-in-part of application No. 29/232,229, filed on Jun. 16, 2005.
(63) Continuation-in-part of application No. 29/232,215, filed on Jun. 16, 2005.
(63) Continuation-in-part of application No. 29/232,220, filed on Jun. 16, 2005.
(63) Continuation-in-part of application No. 29/232,225, filed on Jun. 16, 2005, now Pat. No. D530989.
(63) Continuation-in-part of application No. 29/232,321, filed on Jun. 16, 2005, now Pat. No. D519802.
(63) Continuation-in-part of application No. 29/232,217, filed on Jun. 16, 2005, now Pat. No. D530992.
(63) Continuation-in-part of application No. 29/232,271, filed on Jun. 16, 2005.
(63) Continuation-in-part of application No. 29/232,218, filed on Jun. 16, 2005.
(63) Continuation-in-part of application No. 29/232,248, filed on Jun. 16, 2005.
(63) Continuation-in-part of application No. 29/232,226, filed on Jun. 16, 2005.
(63) Continuation-in-part of application No. 29/232,228, filed on Jun. 16, 2005, now Pat. No. D521287.
(63) Continuation-in-part of application No. 11/239,921, filed on Sep. 30, 2005.
(63) Continuation-in-part of application No. 11/241,332, filed on Sep. 30, 2005.

(51) Int. Cl. B26D 7/06; B27B 29/08

(52) U.S. Cl. 83/401; 83/440.2; 83/720; 83/856

(57) ABSTRACT

A mandoline slicer having a blade, a pivotable platform and a compact, low profile suction device in a housing that is hinged to the front of the slicer so that the suction device may be rotated under the slicer for storage and rotated at least partially outward from the front of the slicer for use. The height of a front edge of the platform is changed in relation of the height of the blade by moving a lever horizontally in a slot in a side of the slicer. The lever is geared so that the changes in the height of the front edge of the platform are incremental. Thus, the thickness of food slices moved over the platform and into the blade may be varied by know incremental amounts. Rear legs, which are foldable under the slicer for storage, contain compartments or slots for convenient, compact storage of slicer attachments.

### RELATED APPLICATIONS

This application is a continuation-in-part of U.S. patent application Ser. No. 29/232,222, filed Jun. 16, 2005; U.S. patent application Ser. No. 29/232,229, filed Jun. 16, 2005; U.S. patent application Ser. No. 29/232,215, filed Jun. 16, 2005; U.S. patent application Ser. No. 29/232,220, filed Jun. 16, 2005; U.S. patent application Ser. No. 29/232,225, filed Jun. 16, 2005; U.S. patent application Ser. No. 29/232,321, filed Jun. 16, 2005; U.S. patent application Ser. No. 29/232,217, filed Jun. 16, 2005; U.S. patent application Ser. No. 29/232,271, filed Jun. 16, 2005; U.S. patent application Ser. No. 29/232,218, filed Jun. 16, 2005; U.S. patent application Ser. No. 29/232,248, filed Jun. 16, 2005; U.S. patent application Ser. No. 29/232,226, filed Jun. 16, 2005; U.S. patent application Ser. No. 29/232,228, filed Jun. 16, 2005; U.S. patent application Ser. No. 11/239,921, filed Sep. 30, 2005; and U.S. patent application Ser. No. 11/241,332, filed Sep. 30, 2005. The aforementioned applications are incorporated herein by reference.

### FIELD OF INVENTION

This invention relates generally to kitchenware and, in particular, to a mandoline slicer for use is slicing fruits, vegetables, and other foods.

### BACKGROUND OF INVENTION

The mandoline slicer is well known in the prior art. The device is set on a work surface. It has a flat upper surface, which may be angled with respect to the work surface. A blade is positioned near the center of the device. A food article is pushed, in sliding fashion, over the upper surface of the slicer, and, as the food article is moved over the blade, it is sliced in uniform slices. The uniform slices of food may then be eaten, served, or mixed or combined with other foods. The slicer, of course, is a very useful kitchen implement, because it yields uniform slices and it is easy to use and relatively stable when used.

Nevertheless, mandoline slicers are relatively large and take up considerable space when stored. The slicer may have multiple blades or attachments for different types of cuts or slices; these, too, must be specially handled for storage. Mandoline slicers also have a tendency to move about on the counter when bulky, sticky, or relatively hard foods are being sliced, in which case the user must keep a solid grip on the slicer so that it does not move about during slicing. If the slicer were to move about during slicing, it could affect the uniformity of the slices, or cause the slicer to tip or fall off the work surface or kitchen counter and, potentially, cause injury.

Many such slicers also are equipped with means to adjust the relative angle or height of the blade and upper surface so that the thickness of slices may be varied. Such adjustments may be made with a knob, ledges, or other types of structures that are suitable to adjust the angle of either the blade, the upper surface of the slicer, or both. Such structures can be difficult to operate or require the user to engage in considerable manipulation of the knob or the parts of the slicer.

It is therefore be desirable to have a mandoline slicer that could be made smaller or more compact for storage, include a convenient structure to store the blades and other cutting attachments, be securable to a counter or work surface during the slicing operation, and have an easy means for adjusting the relative heights of the blade and upper surface of the slicer in a known incremental manner so that the thickness of food slices can be easily and dependably regulated.

It is also desirable to have a low profile, compact device for securing the slicer to the work surface so that the slicer assembly itself does not become bulky or unnecessarily or uncomfortably high for the user when it is secured to the work surface. Further, it is desirable to have such a device which could be moved to a storage position under the slicer, thus reducing the space necessary to store the slicer.

### SUMMARY OF INVENTION

The mandoline slicer of the invention has a compact, low profile suction device in a housing that is hinged to the front of the slicer. The suction device is engaged and disengaged by moving a lever horizontally in a slot in the housing to very firmly secure the front of the slicer to the work surface for use. The housing may be rotated on its hinges to be positioned outside the front of the slicer during use or to be positioned under the slicer for storage.

Food is sliced on the slicer by moving the food from the rear to the front of the slicer. The food is placed on the surface of a rear platform of the slicer and then moved slidingly forward onto a front platform of the slicer. A blade is located in a central portion of the slicer between the rear and front platforms such that, when the food slides from the rear platform to the front platform, the food intersects the blade and is sliced.

The relative heights of the blade and the front of the rear platform determine the thickness of slices that are cut on the slicer. The greater the difference in the heights of the blade and the front of the rear platform, the thicker a slice of food is cut. Thinner slices of food are cut when the difference in the heights of the blade and the front of the rear platform are smaller.

The relative heights of the front of the rear platform and the blade are changed by moving a lever horizontally in a slot in the side of the slicer. The lever easily slides along a sloped flange on the rear platform of the slicer, thus raising and lowering the front of the rear platform. The lever is geared so that the changes in the relative heights of the blade and the front of the rear platform are incremental. As a result, the thickness of food slices may be varied by known incremental amounts.

Rear legs or a rear support of the slicer contain compartments or slots for convenient, compact storage of the blades or attachments, such as a Julienne-style cutter. The rear legs fold under the slicer to provide a compact assembly for storage.

### BRIEF DESCRIPTION OF THE DRAWINGS

FIG. 1 is a perspective view of a slicer of the invention in position for use;

FIG. 2 is a perspective view of the slicer folded for storage;

FIG. 3 is a perspective view of a rear portion of the slicer with a front of a rear platform raised;

FIG. 4 is a perspective view of the rear portion of the slicer with the front of the rear platform lowered;

FIG. 5 is a cross sectional side view of the slicer;

FIG. 6 is a perspective view of the slicer with a blade removed;

FIG. 7 is a rear view of the slicer with a blade accessory removed from a storage slot between rear legs of the slicer;

FIG. 8 is a perspective view of the rear portion of the slicer with the rear platform removed;

FIG. 9 is a perspective view of the rear portion of the slicer with the rear platform removed, the front platform removed, and the handle removed;

FIG. 10 is a top perspective view of the rear portion of the slicer with the rear platform removed and the handle positioned to show that the front of the rear platform (shown in dashed lines), is raised;

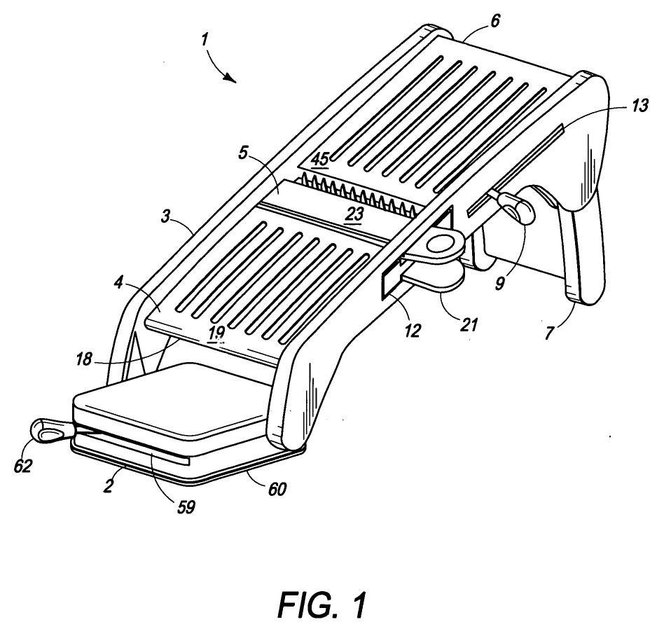

FIG. 1 1 is a top perspective view of the rear portion of the slicer with the rear platform removed and the handle positioned to show that the front of the rear platform (shown in dashed lines) is lowered;

FIG. 12 is a perspective view of the rear platform;

FIG. 13 is a right side view of the rear platform; and

FIG. 14 is a left side view of the rear platform.

### DETAILED DESCRIPTION

Certain terminology will be used in the following description. Words such as “top”, “bottom”, “upper”, “lower”, “upward”, “downward”, “rightward”, “leftward”, “above”, “below”, and the like, refer to those same directions in the properly oriented drawings. Words such as “inward”, “outward”, “inner”, “outer”, and “central”, refer to the same directions or locations at, toward, or away from the geometric center of the object shown or referenced in the properly oriented drawings. This use of such terminology is for convenient reference, is not intended to be limiting (as, for example, if an embodiment of the invention is inverted or reversed), and includes the words specifically mentioned, derivatives thereof, and words of a similar nature or import.

Slicer Assembly

FIGS. 1, 5, and 8 show a slicer 1 of the invention. The slicer 1 has a suction device housing 2, a frame 3, a front platform 4, a blade 5, a rear movable platform 6, rear legs 7, a pivot 8, and a platform handle 9.

Frame

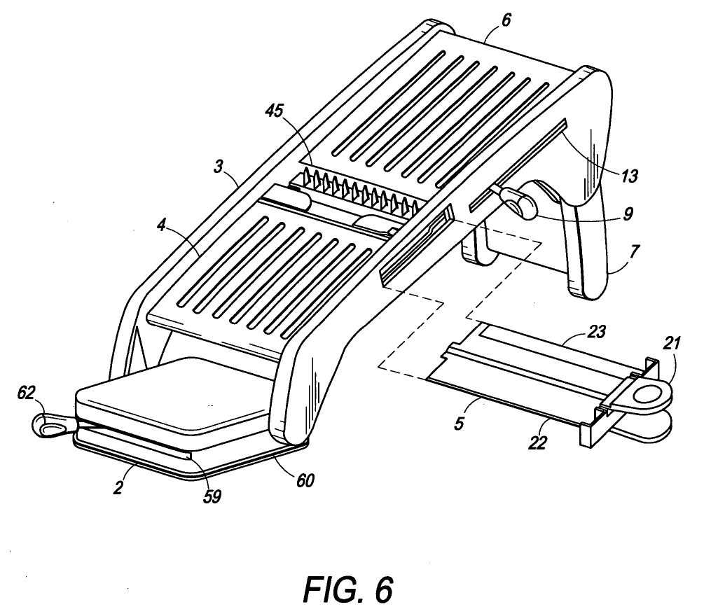

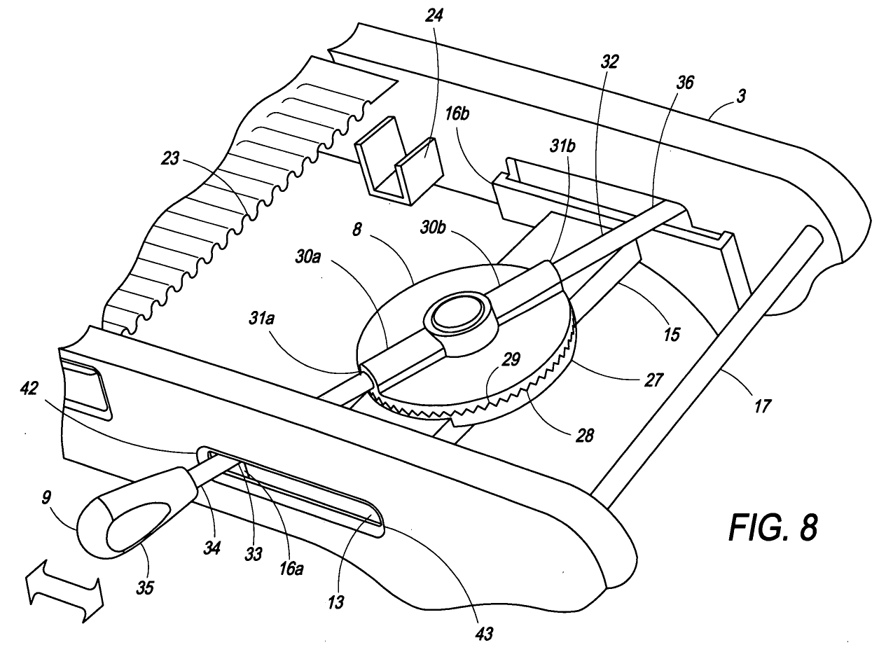

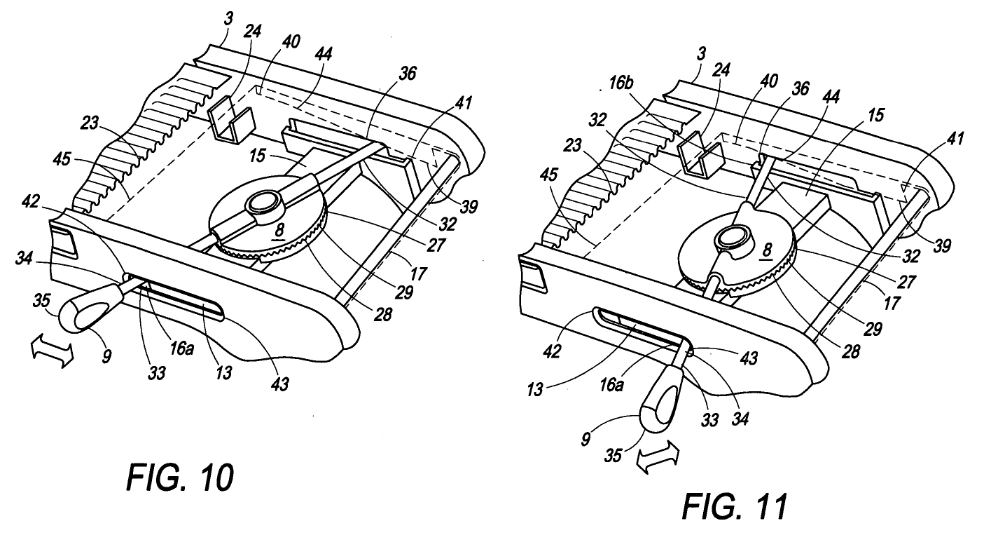

As shown in FIGS. 1 and 9, the frame 3 has a hinge slot 10, a front platform support bar 11, a blade slot 12, a handle slot 13, a leg support bar 14, a pivot support strip 15, a pair of handle supports 16a and 16b, a rear platform support bar 17, and a holder 24 for a Julienne attachment 26. (See FIGS. 5 and 7)

Front Platform

As best shown in FIG. 5, the front platform 4 has a front curled section 18 at a front end 19 thereof, which fits over and around the front platform support bar 11 to secure the front platform 4 to the frame 3. A rear end 20 of the front platform 4 is secured to the frame. The rear end 20 of the platform 4 may be so secured by any conventional means such as tab in a slot in the frame 3, screws or glue on a downward extending flap, or the like.

Blade

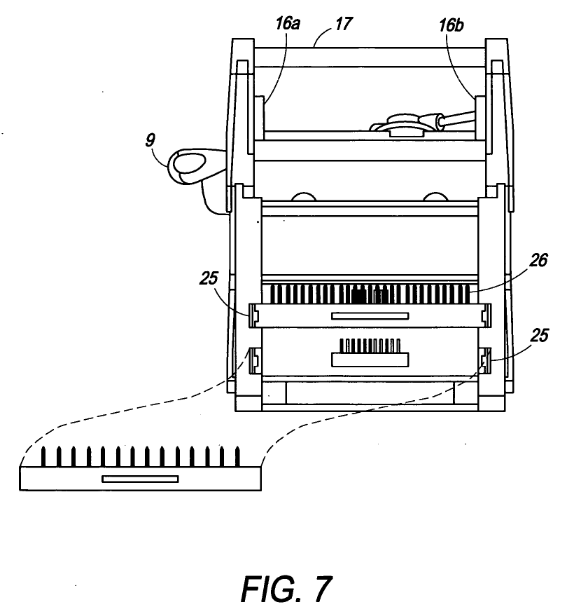

The blade 5 is inserted into and removed from the blade slot 12 via use of a blade handle 21. A frontward portion 22 of the blade 5 fits under the front platform 4; a rearward portion or edge 23 of the blade 5 is exposed to slice food that is moved over the rear platform 6 of the slicer 1. (See FIGS. 5 and 6) The blade handle 21 extends out of the blade slot 12 when the blade 5 is inserted in the slicer 1 so that the handle 21 may be used to remove the blade 5 from the slot 12 when desired. The slicer 1 may be supplied with different types of blades 5 to make different shaped cuts or slices of food. The blade 5 may also have different cutting edges on each side and be reversed in the slot to provide a different type of cutting edge 23.

Rear Legs

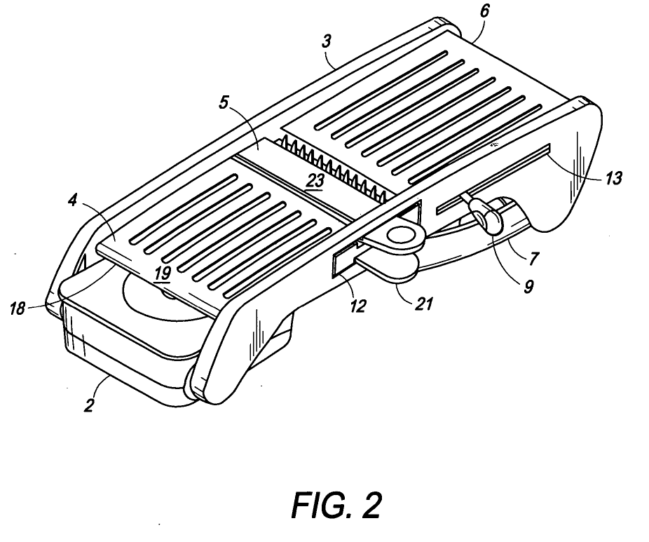

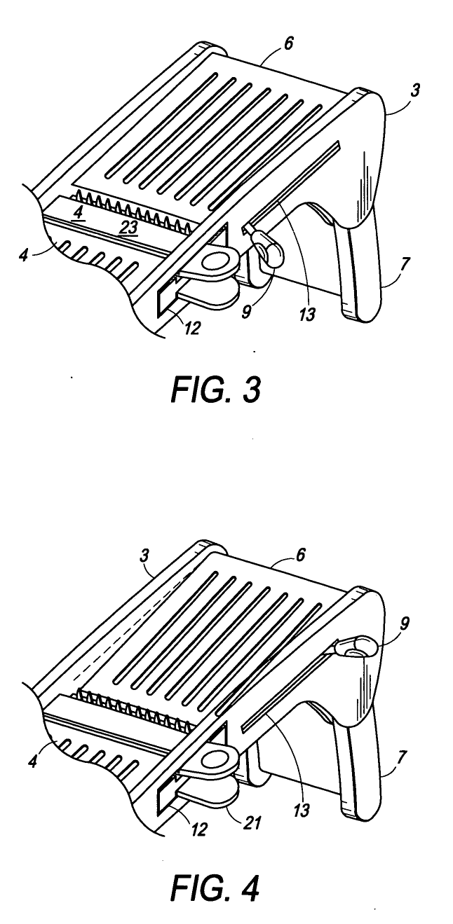

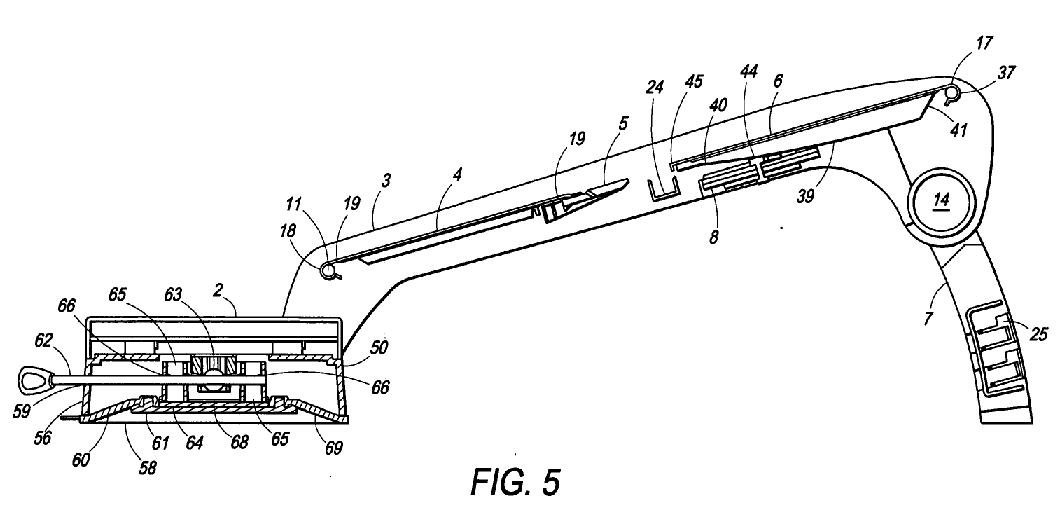

As shown in FIGS. 2 and 9, the rear legs 7 of the slicer 1 are rotatably secured to the leg support bar 14 in any conventional manner so that the rear legs 7 may be rotated to an upright position as shown in FIGS. 1, 3 and 4, for example, or rotated to a folded position under the frame 3, as shown in FIG. 2. In order to accomplish this pivoting motion of the rear legs 7, the legs 7 may have slots or openings that fit around the leg support bar 14, the legs 7 may have an axel that fits within a hole in the support bar 14, or the legs 7 may be hinged in some other suitable manner so that they fold under the frame 3 when the slicer 1 is to be stored. Of course, when the legs 7 are folded under the frame 3, the slicer 1 is in a more compact configuration and takes up less space when it is placed in a storage cupboard or other storage location.

As shown in FIGS. 5 and 7, the rear legs 7 also form slots or compartments 25 to store different types of blades 5 or Julienne cutting attachments 26 when they are not in the blade slot 12 or the Julienne holder 24, respectively, of the slicer 1.

Pivot Base

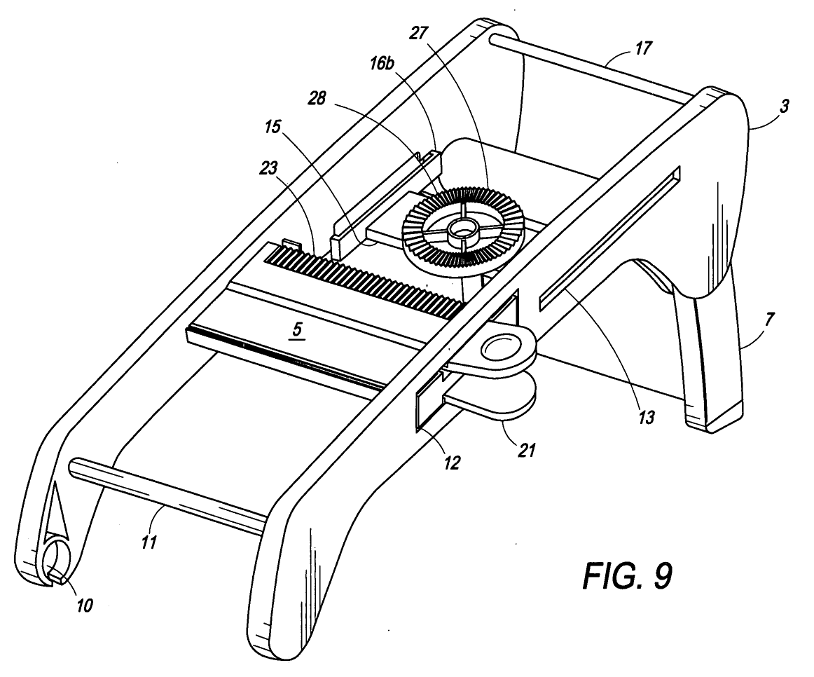

A pivot base 27 is formed on or attached to the pivot support strip 15 of the frame 3 of the slicer. The pivot base 27 has triangular section, radial teeth 28. (See FIGS. 8 and 9)

Pivot

The pivot 8 has triangular section, radial teeth 29 that cooperate with the triangular section, radial teeth 28 of the pivot base 27 so that they movably fit together as shown in FIGS. 8, 10, and 11. Thus, as pivot 8 is rotated, its teeth 29 slide over, or up and down over, the teeth 28 of the pivot base 27 such that the pivot 8 may be rotated or pivoted in increments over the pivot base 27. This construction allows the pivot 8 to be rotated or pivoted in specific known stages, increments, or distances over pivot base 27.

As shown in FIG. 8, tubes or cylinders 30a and 30b are formed on an upper side of pivot 8. The tubes 30a and 30b form holes 3 la and 3 lb. Alternatively, the cylinders 30a and 30b may be formed as a single cylinder with a single hole.

Handle and Bar

The handle 9 is inserted into and through hole 31 a as shown in FIG. 8. A bar 32 is inserted in the hole 31b of tube 30b. An inward portion 33 of the handle 9 rests slidingly on one of the handle supports 16a. An end 34 of the handle 9 extends through and outward from the handle slot 13 of the frame 3 and ends in a grip 35. An end 36 of bar 32 rests slidingly on handle support 16b. (See FIGS. 8, 10, and 11)

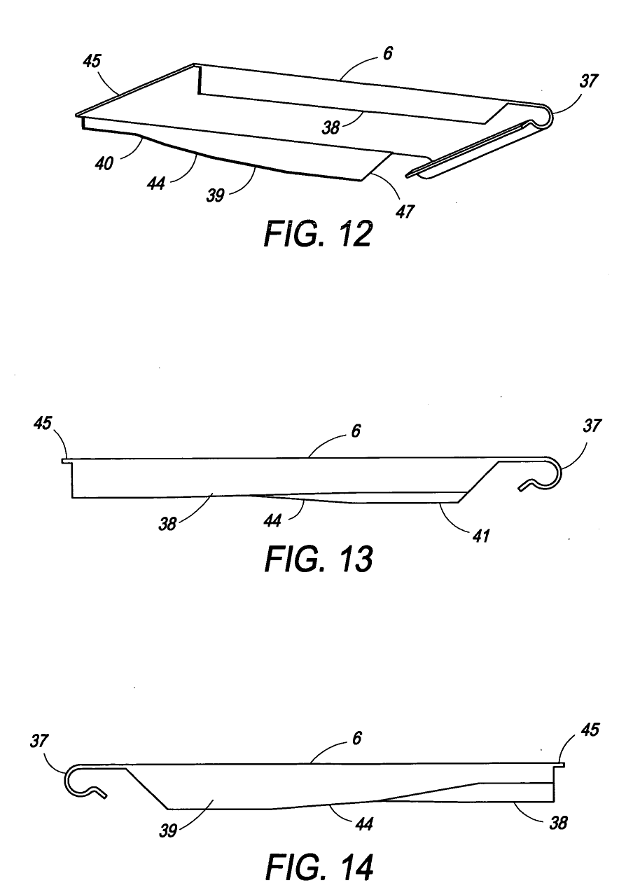

So constructed, the handle 9 may be moved sideways (approximately horizontally) via grip 35 in handle slot 13. As the handle 9 is moved sideways in the handle slot 13, the pivot 8 rotates or pivots with the handle 9 and moves incrementally over the pivot base 27. The handle 9 may be so moved, in specific increments, from one side of the handle slot 13 to the other and back again. As the handle 9 moves, the inward portion 33 of handle 9 slides along the surface of the handle support 16a, and the end 36 of bar 32 slides along the surface of handle support 16b, as shown in FIGS. 10, 11, and 12-14.

Rear Movable Platform

As shown in FIGS. 5, and 12-14, the rear movable platform 6 has a rear curled section 37 which fits over and around the rear platform support bar 17 of the frame 3 to rotatably or pivotably secure the rear platform 6 to the rear platform support bar 17 of the frame 3.

The rear movable platform 6 also has downward extending flanges 38 and 39 that extend downward at right angles from the platform 6. (See FIGS. 5, 10, 11, and 12-14) Flange 39 is sloped from the rear toward the front of the slicer 1 such that the flange 39 is shorter at a front 40 thereof than at a rear 41 thereof. (See FIG. 12) As shown in FIGS. 10 and 11, when the handle 9 is at the frontward part 42 of the handle slot 13, the flange 38 rests on handle 9, and the longer, rear part 41 of the flange 39 rests on the bar 32. When the handle 9 is at a rearward part 43 of the handle slot 13, the shorter, front part 40 of the sloped flange 39 rests on the bar 32, and the flange 38 rests on the handle 9. The flange 38 may be angled downward, or shaved to taper it downward, toward the rear curled end 37 of the platform 6. When the handle 9 is midway between the frontward part 42 and the rearward part 43 of the handle slot 13, the flange 38 rests on the handle 9, and a sloped portion 44 of flange 39 rests on the bar 32. (See FIGS. 10, 11, and 12-14)

Incremental Adjustment of Angle or Slope of Rear Movable Platform

Thus, when the handle 9 is at the frontward part 42 of the handle slot 13, the flange 38 rests on handle 9, the longer, rear part 41 of flange 39 rests on bar 32, and a front edge 45 of the rear platform 6 is nearly even with the rearward portion or edge 23 of the blade 5. If food is then moved on the surface of platform 6 from the rear toward the front of the slicer 1, the food cut is very thin, because the platform 6 is nearly even with the rear edge 23 of the blade 5. (See FIGS. 10-12)

When the handle 9 is at the rearward part 43 of the handle slot 13, the flange 38 rests on handle 9, the shorter, front part 40 of the sloped flange 39 rests on bar 32, and the front edge 45 of the rear platform is lower than the rearward portion or edge 23 of the blade 5. (The platform 6 is also lower at its front edge 45 that at its rear curled portion 37 and, thus, slopes from the rear of the slicer down toward the front of the slicer.) If, with the platform 6 in this position, food is moved on the surface of the platform 6 from the rear toward the front of the slicer 1, a relatively thick cut is made in the food, and a thick slice of food is produced, because the front edge 45 of the platform is lower than the rearward portion or edge 23 of the blade 5.

When the handle 9 is midway between the frontward part 42 and the rearward part 43 of the handle slot 13, the flange 38 rests on the handle 9, and the sloped portion 44 of flange 39 rests on the bar 32. With the handle 9 in this position, the front edge 45 of the rear platform 6 is somewhat lower than the rearward portion or edge 23 of blade 5, but not as much lower as when the handle 9 is at the rearward part 43 of the handle slot 13. (In other words, the platform 6 is lower at its front edge 45 that at its curled portion 37 and slopes from the rear of the slicer 1 down toward the front of the slicer 1, but does not slope as much as when the handle 9 is at the rearward part 43 of the handle slot 13.) If, with the platform 6 in this position, food is moved on the surface of the platform 6 from the rear toward the front of the slicer 1, the food slice is cut, but the slice that is cut is not a thick as when the handle 9 is at the rearward part 43 of the handle slot 13.

More specifically, as the handle 9 is moved from the frontward part 42 and the rearward part 43 of the handle slot 13, the front edge 45 of the rear platform 6 is lowered—i.e., the angle or degree of slope of the rear platform 6 is increased. As the angle or degree of slope of the rear platform 6 is increased, the front edge 45 of the rear platform 6 becomes increasingly lower than the rearward portion or edge 23 of the blade 5, thus producing thicker slices of food when food is moved from the rear to the front of the slicer over the rear and front platforms 6 and 4, respectively. Thus, by moving the handle 9 different distances in the handle slot 13, the thickness of the slice of food cut on the slicer can be determined and regulated. When the handle 9 is moved toward the frontward part 42 of the handle slot 13, the slices produced are thin; when the handle 9 is moved toward the rearward part 43 of the handle slot 13, the slices produced are thicker.

Moreover, since the handle 9 and the bar 32 are connected to the pivot 8, and pivot 8 has the teeth 29 that cooperate with and slide over the teeth 28 of the pivot base 27 as the handle 9 is moved in the handle slot 13, the movement of the handle 9 in the handle slot 13 is incremental—i.e., it moves in discrete steps from one end of the handle slot 13 to the other. And, since the movement of the handle 9 in the slot 13 is in discrete, incremental steps, the angle or slope of the rear platform 6 is also changed in discrete, incremental steps, because the movement of the handle 9 changes the slope or angle of the rear platform 6. Thus, the thickness of the slices of food moved over the slicer 1 can be determined, changed, and regulated in discrete, incremental steps by moving the handle 9 to different positions in the handle slot 13.

Suction Device Housing

FIG. 9 shows a hinge slot 10 in the front portion or leg of frame 3 of the slicer 1. A second hinge slot (not shown) is opposite the hinge slot 10 in the other leg of frame 3 of the slicer 1. A pair of hinge bars (not shown) are attached to, or formed as a part of, opposite sides of the suction device housing 2 in locations such that one of the hinge bars fits into, and rotates within, each of the hinge slots 10 in the front of the frame 3. The hinge bars rotate in the hinge slots 10 so that the suction device housing 2 may be rotated from a storage position underneath the frame 3 to an engagement position out in front of the frame 3 of the slicer 1.

So constructed, the housing 2 may be rotated underneath the frame 3, as shown in FIG. 2, or it may be rotated to a position out in front of the frame 3, as shown in FIGS. 1, 5, and 6. When the suction device housing 2 is rotated underneath the frame 3, the housing is compactly stored under the frame 3 of the slicer 1 so that the slicer assembly 1 is in a more compact arrangement for storage in a cupboard or other storage location. Since, as described above, the legs 7 may also be folded under the frame 3, the slicer assembly 1 may be made even more compact for storage by folding both the suction housing 2 and the rear legs 7 under the frame 3 when the slicer 1 is to be placed in a storage location.

Although the hinge slot 10 and bar arrangement are described herein, it is understood that any hinge arrangement for the suction housing 2 could be used for the stated purpose of rotating the suction housing 2 from a position out in front of the slicer frame 3 to a position underneath the slicer frame 3 or from a position underneath the frame 3 to a position out in front of the frame 3. For example, an axle could be used for this purpose, or pins could extend from the frame 3 and be rotatingly inserted to the suction housing 2 to accommodate such rotation. Indeed, any structure that would permit the suction housing 2 to rotate under and out from under the frame 3 would be satisfactory for this purpose.

Suction Device

The suction device housing 2 of the slicer 1 houses a suction assembly 50, as shown in FIG. 5.

The suction assembly 50 comprises a suction pad 60, a suction pad plate 61, a handle 62, and a pivot 63. The suction plate 61 has a top side 64. Two spaced-apart bridge-like structures 65 extend away and upward from the top side 64 of the plate 61. Each bridge-like structure 65 has an underside 66 that is ramped or sloped. The pivot 63 is situated between the bridge-like structures 65.

The suction pad 60 is larger in diameter than the suction pad plate 61. The suction pad has a central portion 68 and an outer portion 69. When the suction pad 60 is placed on the top side 64 of the suction pad plate 61, the outer portion 69 of the suction pad 60 extends beyond and outward from the suction pad plate 61. The central portion 68 of the suction pad 60 is situated on and connected to the top side 64 of the plate 61.

The handle 62 extends from the sloped underside 66 of one of the bridge-like structures 65, through a hole 70 in the pivot 63, along the sloped underside 66 of the other bridge-like structure 65, and outward thorough the elongated slot 59 in the side 56 of the suction device housing 2 above the bottom opening 58 of the suction device housing 2. The handle 62, so situated, is in sliding contact with the sloped undersides 66 of the bridge-like structures 65.

The suction assembly 50 is oriented so that the outer portion 69 of the suction pad 60, which extends outward from the plate 61, makes contact with the counter or work surface through the bottom opening 58 of the suction device housing 2.

Suction device 50 is operated by moving its handle 62 from one side of its elongated slot 59 to the other.

Movement of the handle 62 in one direction causes the handle 62 to slide along the upward slopes of the underside 65 of the bridge-like structures 65. As the handle 62 slides along the slope underside 65, it pulls the plate 61from which the bridge-like structures 65 extend, in turn causing the plate 61 to pull the central portion 68 of the suction pad 60 away from the counter, while the outer portion 69 of the suction pad 60 remains in contact with the counter. As the central portion 68 of the suction pad 60 is pulled away from the surface, the air pressure between the central portion 68 of the suction pad 60 and the counter decreases, creating a partial vacuum under the central portion 68 of the suction pad 60, which, in turn causes the outer portion 69 of the suction pad 60, which is still in contact with the counter, to adhere to the counter.

Movement of the handle 62 in the opposite direction in the slot 59 relaxes the central portion 68 of the suction pad 60, causes the central portion of the suction pad 60 to move toward the counter, increases the pressure under the central portion 68 of the suction pad 60, dispels the partial vacuum, and allows the suction pad 60 to be easily removed from the surface to which it is was formerly mated.

Operation of the Suction Device

In order to operate the suction device 50 and engage it with a work surface, the suction device housing 2 is rotated from its storage position under the frame 3 to an engagement position out in front of the slicer 1. (The legs 7 are also unfolded from under the frame 3 of the slicer 1 so that the rear portion of the slicer 1 may stand on the work surface.)

The slicer 1 is then placed in a desirable location on a work surface or counter. In this position, the outer portion 69 of the suction pad 60 is in contact with the countertop. The handle 62 of the suction device 50 is moved in the elongated slot 59. As the handle 62 moves in the slot 59 the central portion 68 of the suction pad 60 is raised upward, creating a partial vacuum under the central portion 68 of the suction pad 60 while the outer portion of the 69 of the suction pad 60 remains on the countertop. The vacuum or suction so created under the central portion 68 of the suction pad causes the slicer 1 to stick or adhere to the counter in the desired location.

So adhered, the slicer1 will not be moved or tipped on the counter or work surface when the slicer 1 is in operation.

If it is desired to move the slicer 1 to a different location, the handle 62 of the suction device 50 is moved in the opposite direction in the slot 59 in the side 56 of the suction device housing 2 to relieve the partial vacuum under the central portion 68 of the suction pad 60. The slicer 1 may then be moved to a different location on the countertop, where it may again be adhered by suction in the manner stated above.

Operation of Slicer

The slicer 1 is removed from any location in which it might be stored. The rear legs 7 are folded out from beneath the frame 3, and the suction device housing 2 is rotated on its hinge connections to move it from under the frame 3 of the slicer 1 until it extends outward from the front of the slicer 1. The slicer 1 is then placed in a convenient location on a work surface. When the slicer 1 is so positioned, the lever or handle 62 of the suction assembly 50 is moved in slot 59 until the suction device 50, and thus the slicer 1, is secured to the work surface.

A Juilenne cutting attachment 26 may removed from one of the slots 25 between the rear legs 7 of the slicer 1 and inserted into the slot 12 in the frame 3 so that Julienne style cutting is enabled. However, if a Julienne style cut is not desired, the Julienne attachment may be left in one of the storage slots 25 between the rear legs 7 of the slicer 1.

The Lever or handle 9 is then moved incrementally in slot 13 until the front 45 of the rear platform 6 is a distance below the rearward edge 23 of the blade 5 sufficient to make slices of a thickness desired by the user. An article of food is then placed on the rear platform 6 and moved from the rear of the slicer 1 toward the front of the slicer. As the food is so moved, it is intersected by the blade 5, which slices a portion of food from the article. (A block or handle, which is not shown, may be placed on top of the food before it is moved from the rear toward the front of the slicer 1 to protect the user from being cut by the blade.)

Upon completion of the slicing, the lever 62 is moved in the opposite direction in slot 59 to release the suction device 50 from the work surface. The slicer 1 may then be cleaned. Thereafter, the suction housing 2 is rotated back under the frame 3, the blade 5 may be removed from slot 12 and stored in one of the slots 25 in the legs 7, and the legs may be rotated back under the frame 3. The slicer 1 is then compacted for storage and may be stored.

It is understood that while certain forms of this invention have been illustrated and described, it is not limited thereto except insofar as such limitations are included in the following claims and allowable functional equivalents thereof.

1. A food slicer comprising:
(a) a platform pivotable on an end of the slicer;
(b) a blade facing an end of the platform;
(c) a handle that slides along a portion of the platform to raise and lower the end of the platform

2. The slicer of claim 1 wherein the platform has a curled end, the curled end fitting over a bar on the end of the slicer such that the platform pivots on the bar.

3. The slicer of claim 1 wherein raising and lowering the end of the platform determines the thickness of slices that can be cut on the slicer by increasing and decreasing the height of the platform relative to the blade.

4. The slicer of claim 1 wherein progressively lowering the end of the platform increases the thickness of slices that can be cut on the slicer.

5. The slicer of claim 1 wherein the handle moves incrementally.

6. The slicer of claim 1 wherein the end of the platform is raised and lower incrementally.

7. The slicer of claim 1 wherein the handle is connected to a pivot with teeth, the pivot movably resting on a pivot base having teeth that cooperate with the teeth on the pivot to provide incremental movement of the handle.

8. The slicer of claim 1 wherein the handle is connected to a pivot with teeth, the pivot movably resting on a pivot base with teeth that cooperate with the teeth on the pivot to provide incremental movement of the end of the platform when the handle is moved in the slot.

9. The slicer of claim 1 wherein the frame has rear legs having slots for storage of slicer attachments.

10. The slicer of claim 1 wherein a housing is pivotably connected to a front of the frame, the housing containing a suction device.

11. The slice of claim 10 wherein the suction device has a handle extending outward through a slot in the housing, the handle movable in the slot to secure the suction device to a work surface.

12. The slicer of claim 1 wherein the handle extends outward through a slot in the frame.

13. An adjustable platform for a food slicer having a blade and a handle, the platform comprising:
(a) a plate having at least one downward extending flange, the flange having a shaped bottom;
(b) an end of the plate rotatably secured to the fame;
(c) an opposite end of the plate facing the blade of the slicer, the opposite end positionable at selected locations by sliding the handle along the shaped bottom of the flange.

14. The platform of claim 13 wherein progressively lowering the end of the plate increases the thickness of slices that can be cut on the slicer.

15. The platform )f claim 13 wherein the plate moves incrementally.

16. The slicer of claim 13 wherein the end of the plate is raised and lowered incrementally.

17. A slicer for slicing food moved into contact with a slicer blade, the slicer comprising:
(a) a platform pivotably connected to a rear portion of the slicer;
(b) the platform having an upper side along which food is moved into contact with the blade; and
(c) a handle that slides along an sloped edge of the platform to raise and lower an end of the platform facing the blade.

18. The slicer of claim 17 wherein the platform has a curled end, the curled end fitting over a bar on the end of the slicer such that the platform pivots on the bar.

19. The slicer of claim 17 wherein the end of the platform facing the blade is raised and lower incrementally.

20. The slicer of claim 17 wherein the handle is connected to a pivot with teeth, the pivot movably resting on a pivot base with teeth that cooperate with the teeth on the pivot to provide incremental movement of the end of the platform facing the blade when the handle is moved.

21. The slicer of claim 17 wherein the rear portion of the slicer has rear legs forming at least one compartment for storing slicer attachments.

22. The slicer of claim 17 wherein a housing is pivotably connected to a front of the slicer, the housing containing a suction device.

23. The slice of claim 22 wherein the suction device has a handle extending outward through a slot in the housing, the handle movable in the slot to secure the suction device to a work surface.

24. A food slicer comprising:
(a) a frame;
(b) a blade installable in the frame;
(c) a platform pivotably connected to the frame, an end of the platform facing the blade; and
(d) a handle movable along a flange on the platform to raise and lower the end of the platform relative to the blade.

25. A food slicer comprising:
(a) a frame having a blade;
(b) a suction device contained in a housing that is rotatably connected to the frame;
(c) the housing is rotatable from a storage position under the frame to an engagement position that extends at least partially outward from the frame;
wherein, when the suction device is engaged with a work surface, food may be moved into the blade of the slicer without moving the slicer on the work surface.
